(19) United States
(12) Patent Application Publication
(10) Pub. No.: US 2026/0014741 A1
(43) Pub. Date: Jan. 15, 2026

(54) INJECTION MOLDING MACHINE AND INJECTION MOLDING SYSTEM

(71) Applicant: SUMITOMO HEAVY INDUSTRIES, LTD., Tokyo (JP)

(72) Inventors: Tatsuya KAWAGUCHI, Chiba-shi (JP); Hirotsugu MARUMOTO, Tokyo (JP)

(21) Appl. No.: 19/216,825

(22) Filed: May 23, 2025

(30) Foreign Application Priority Data
Jul. 12, 2024 (JP) 2024-112358

(51) Int. Cl. B29C 45/07; B29C 45/02; B29C 45/17

(52) U.S. Cl. CPC B29C 45/07; B29C 45/02; B29C 45/1775

(57) ABSTRACT

An injection molding machine includes: a mold for molding a molten resin; an injection unit including an injection port through which the molten resin is injected; and a connection member having a pipe shape that is disposed between the mold and the injection port, and through which the molten resin injected from the injection port is input from one end and output from the other end to the mold, in which, when the injection unit slightly moves in a direction away from the mold, a gap with which the connection member is detachable is formed between the injection unit and the mold.

### CROSS-REFERENCE TO RELATED APPLICATIONS

This application claims priority to Japanese Patent Application No. 2024-112358, filed on Jul. 12, 2024, which is incorporated by reference herein in its entirety.

### BACKGROUND

### Technical Field

A certain embodiment of the present invention relates to an injection molding machine and an injection molding system.

### Description of Related Art

In order to directly input a molten resin output from a device decontaminating contaminants included in a resin to be recycled into an injection molding machine performing injection molding using the molten resin as a material, the device outputting the molten resin and the injection molding machine may be connected through a pipe. In this case, for example, a connecting pipe including a sleeve-type expandable pipe coupling serving as a coupling for the pipe may be provided in order to absorb movement of a position of an injection unit of the injection molding machine caused by a purge operation or the like (for example, the related art).

### SUMMARY

According to an embodiment of the present invention, there is provided an injection molding machine including: a mold for molding a molten resin; an injection unit including an injection port through which the molten resin is injected; and a connection member substantially having a pipe shape that is disposed between the mold and the injection port, and through which the molten resin injected from the injection port is input from one end and output from the other end to the mold, in which, when the injection unit slightly moves in a direction away from the mold, a gap with which the connection member is detachable is formed between the injection unit and the mold.

The injection unit may slightly move in the direction away from the mold by elastically deforming a pipe through which the molten resin flows, and the pipe through which the molten resin flows may be returned to a state in which the pipe is not elastically deformed, by returning the injection unit in a slightly moved state to an original position.

The connection member may be detachably fixed to the mold when the injection unit slightly moves in the direction away from the mold.

A hemispherical recess formed in an inlet of a sprue fittable with a rounded shape of a tip end of the injection port in the mold and a hemispherical recess formed at the one end of the connection member may have approximately the same shape, and the rounded shape of the tip end of the injection port and a rounded shape of the other end of the connection member may be approximately the same shape.

According to an embodiment of the present invention, there is provided an injection molding system including: an injection molding machine including a mold for molding a molten resin, an injection unit including an injection port through which the molten resin is injected, and a connection member substantially having a pipe shape that is disposed between the mold and the injection port, and through which the molten resin injected from the injection port is input from one end and output from the other end to the mold, in which, when the injection unit slightly moves in a direction away from the mold, a gap with which the connection member is detachable is formed between the injection unit and the mold; an output unit that outputs the molten resin; and a connecting pipe that connects the output unit and the injection unit, and through which the molten resin output from the output unit flows to the injection unit.

### BRIEF DESCRIPTION OF THE DRAWINGS

FIG. 1 is a diagram illustrating an example of an overall configuration of an injection molding system according to the present embodiment.

FIG. 2 is a diagram illustrating a state of a purge operation of an injection unit of an injection molding machine constituting the injection molding system in FIG. 1.

FIG. 3 is a diagram illustrating an example of a configuration of a connection member.

FIG. 4 is a diagram illustrating an example of a state where an injection cylinder, the connection member, and a mold are connected.

FIG. 5 is a diagram illustrating an example of a state where the connection member is detached.

FIG. 6 is a flowchart illustrating a flow of processing when the injection unit performs the purge operation.

### DETAILED DESCRIPTION

When the connecting pipe including the sleeve-type expandable pipe coupling is provided, the sleeve slides in accordance with movement of the position of the injection unit and moves between the inside and the outside of the pipe. Thus, the molten resin passing through the inside of the pipe may be exposed to the outside of the pipe while being stuck on a surface of the sleeve. In this case, when the sleeve slides, the exposed molten resin may be rubbed to be carbonized and mixed into the molten resin as a solid foreign matter. Meanwhile, in performing the purge operation or the like of the injection unit, it is required to form a predetermined space between the injection unit and a mold.

It is desirable to form a space for performing a purge operation or the like between an injection unit and a mold of an injection molding machine without significantly deforming a part of a connecting pipe for directly inputting an output molten resin into the injection molding machine through sliding or the like.

Hereinafter, an embodiment of the present invention will be described in detail with reference to the accompanying drawings.

### Configuration of Injection Molding System 1

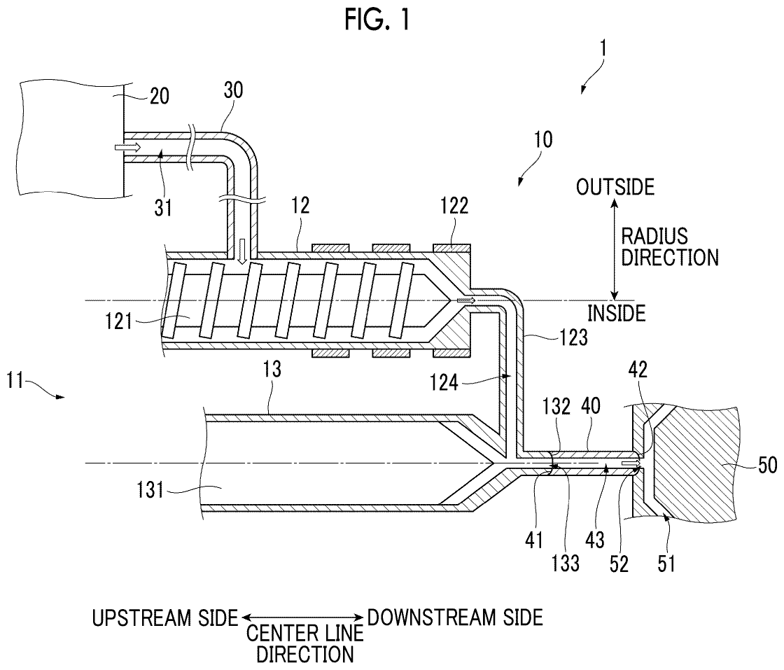

FIG. 1 is a diagram illustrating an example of an overall configuration of an injection molding system 1 according to the present embodiment.

The injection molding system 1 illustrated in FIG. 1 is a system configured to include an injection molding machine 10 that performs injection molding using a molten resin, an output unit 20 that outputs the molten resin to the injection molding machine 10, and a connecting pipe 30 that connects the output unit 20 and the injection molding machine 10. In the injection molding system 1, the injection molding machine 10 seen from the output unit 20 is a device disposed on a downstream side because the molten resin is output from the output unit 20 to the injection molding machine 10.

The injection molding machine 10 and the output unit 20 are connected through the connecting pipe 30. The connecting pipe 30 is a metal pipe that is partially bent, and a space 31 serving as a flow path through which the molten resin flows is formed inside the connecting pipe 30. Thus, the connecting pipe 30 withstands heat and pressure for the flow of the molten resin. An inner surface of the connecting pipe 30 is smooth and has a non-retentive structure in which the molten resin is unlikely to be left. The connecting pipe 30 has an end portion connected to the output unit 20 on an upstream side and an end portion connected to the injection molding machine 10 on the downstream side. Thus, as indicated by arrows in FIG. 1, the molten resin output from the output unit 20 is input into the injection molding machine 10 by flowing through the connecting pipe 30.

### Injection Molding Machine 10

The injection molding machine 10 is a molding machine used for manufacturing a molding product using a molten resin as a material. Since the injection molding machine 10 is connected to the output unit 20 through the connecting pipe 30, the injection molding machine 10 receives supply of the molten resin output from the output unit 20 and enables manufacturing of a molding product using the molten resin.

The injection molding machine 10 includes an injection unit 11 that injects the molten resin, which is the material, into a mold 50 by heating the molten resin. The injection unit 11 includes a plasticizing cylinder 12 that delivers a required amount of the molten resin by heating the molten resin, and an injection cylinder 13 that injects the molten resin delivered from the plasticizing cylinder 12 into the mold 50. The plasticizing cylinder 12 includes a screw 121 that heats the molten resin input through the connecting pipe 30, and a band heater 122 that heats the plasticizing cylinder 12.

The plasticizing cylinder 12 heats the molten resin using shear heat generated by screw rotation of the screw 121 and heat emitted from the band heater 122. For example, the band heater 122 is configured to include a lightweight and thin cylindrical heater in which a nichrome wire is insulated with a heat-withstanding mica plate, and of which the exterior is formed with a stainless steel plate. The band heater 122 is disposed on an outer peripheral surface of the plasticizing cylinder 12.

A pipe 123 for delivering the molten resin heated by the plasticizing cylinder 12 to the injection cylinder 13 is disposed in an end portion of the plasticizing cylinder 12 on the downstream side in the center line direction. The pipe 123 is a metal pipe that is partially bent, and a space 124 serving as a flow path through which the molten resin flows is formed inside the pipe 123. Thus, the pipe 123 withstands heat and pressure for the flow of the molten resin. An inner surface of the pipe 123 is smooth and has a non-retentive structure in which the molten resin is unlikely to be left.

The injection cylinder 13 includes a plunger 131 that pressurizes the molten resin delivered from the plasticizing cylinder 12 through the pipe 123 to the downstream side in the center line direction, and an injection port 133 for injecting the pressurized molten resin into the mold 50. In the related art, the whole injection unit 11 is moved to the downstream side in the center line direction to bring the injection port 133 into contact with an inlet 52 of a sprue 51 that is a flow path through which the molten resin flows into the mold 50. In this state, the molten resin is injected from the injection port 133. Meanwhile, in the present embodiment, a connection member 40 is attached between the injection port 133 and the mold 50. Thus, the molten resin is injected into the mold 50 through the connection member 40.

### Output Unit 20

The output unit 20 is a device that outputs the molten resin. For example, the output unit 20 outputs the molten resin by decontaminating contaminants included in a resin such as a PET bottle to be recycled using a mechanical recycling (mechanical reuse) or chemical recycling (chemical reuse) method. The output unit 20 is connected to the connecting pipe 30 and is fixed in position. The molten resin output from the output unit 20 is input into the injection molding machine 10 through the connecting pipe 30.

The term “mechanical recycling” refers to a series of processes such as obtaining the molten resin by exposing a resin such as a collected used PET bottle to a high temperature, and decontaminating contaminants left in the molten resin by diffusing the contaminants in a vacuum in the output unit 20. The term “chemical recycling” refers to a series of processes of decontaminating contaminants by sorting, chemically decomposing, and repolymerizing a resin such as a collected used PET bottle.

### Connection Member 40

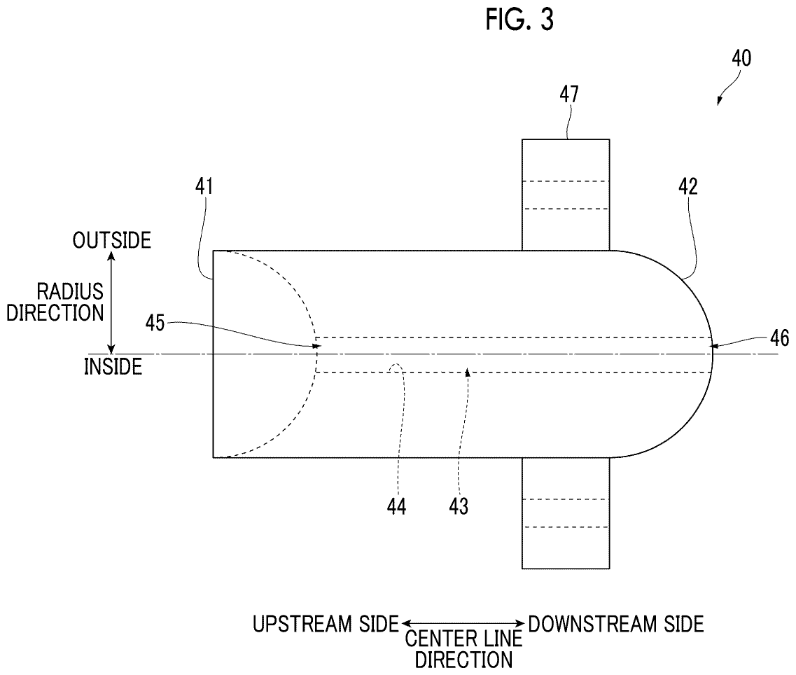

The connection member 40 is a linear metal pipe, in which a space 43 serving as a flow path through which the molten resin flows is formed. An end portion 41 of the connection member 40 on the upstream side is in contact with an end portion 132 of the injection cylinder 13 on the downstream side. An end portion 42 of the connection member 40 on the downstream side is detachably fixed to the inlet 52 of the sprue 51 of the mold 50. Thus, as indicated by an arrow in FIG. 1, the molten resin injected from the injection port 133 of the end portion 132 of the injection cylinder 13 flows through the space 43 inside the connection member 40 and is injected into the mold 50. A detailed configuration of the connection member 40 will be described later with reference to FIG. 3.

### Mold 50

The molten resin inside the mold 50 is molded through a mold opening and closing operation, and a molding product (for example, a product or a preform of a product) is completed by solidifying the molten resin through cooling. The mold opening and closing operation of the mold 50 is performed by a mold clamping unit (not illustrated).

### Purge Operation Of Injection Unit 11

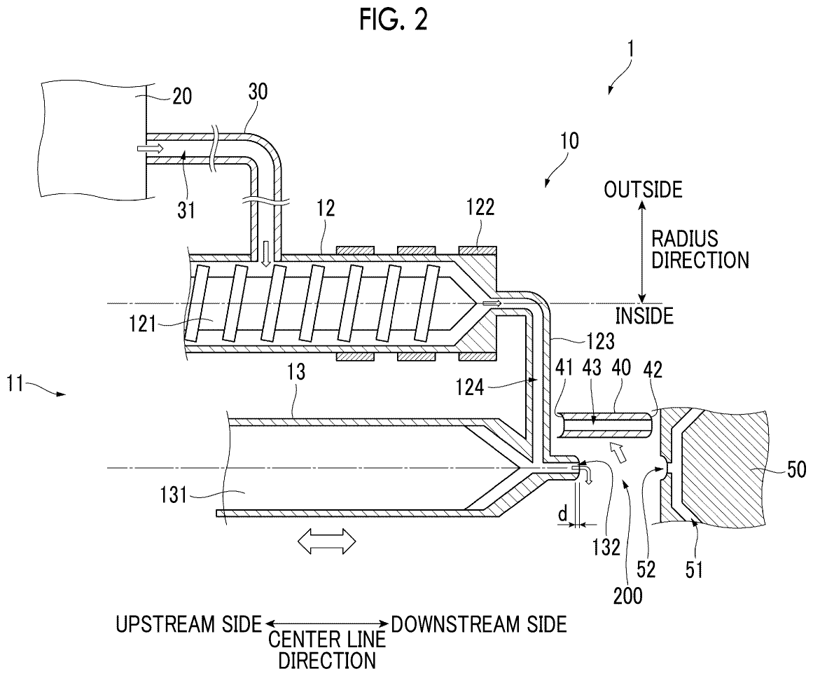

FIG. 2 is a diagram illustrating a state of the purge operation of the injection unit 11 of the injection molding machine 10 constituting the injection molding system 1 in FIG. 1. Carbonized resins accumulate inside the injection unit 11 of the injection molding

machine 10. The accumulation of the carbonized resins is a phenomenon in which the molten resin input into the injection unit 11 is left and burns to be carbonized and accumulates in the screw 121 inside the plasticizing cylinder 12. When the carbonized resins accumulate, the accumulated carbonized resins peel off and cause molding defects. Thus, in order to eliminate the accumulation of the carbonized resins, the injection unit 11 is periodically subjected to the purge operation that is an operation of forcing a degraded molten resin or the carbonized resins to be exhausted from the injection cylinder 13 to the outside.

In order to perform the purge operation of the injection unit 11, it is required to secure a space for performing the purge operation between the injection cylinder 13 and the mold 50. In the related art, this point is addressed by securing a space by moving the whole injection unit to the upstream side. In this case, since the position of the output unit 20 is fixed, a sleeve having a cylindrical shape is provided in a part (a part extending in the center line direction in FIG. 2) of a connecting pipe connecting the output unit 20 and the injection unit, and movement of the injection unit is absorbed by sliding the sleeve. However, when the sleeve of the connecting pipe slides, as described above, the molten resin exposed to the outside may be carbonized and mixed with the molten resin inside the connecting pipe as a solid foreign matter.

Meanwhile, in the injection molding system 1 according to the present embodiment, as described above, the connecting pipe 30 connecting the output unit 20 and the injection unit 11 is a metal pipe that is partially bent, and does not include a sleeve such as the connecting pipe in the related art. Thus, a positional relationship between the end portion of the connecting pipe 30 on the upstream side (a part connected to the output unit 20) and the end portion of the connecting pipe 30 on the downstream side (a part connected to the plasticizing cylinder 12) slightly changes. The reason why the positional relationship “slightly changes” is that, since the connecting pipe 30 is partially bent, it is configured to allow the entire connecting pipe 30 to bend through slight elastic deformation.

In the injection molding system 1, the pipe 123 disposed in the end portion, on the downstream side, of the plasticizing cylinder 12 constituting the injection unit 11 is a metal pipe that is partially bent, as described above. Thus, a positional relationship between the end portion (a part connected to the plasticizing cylinder 12) on the upstream side and the end portion (a part connected to the injection cylinder 13) on the downstream side of the pipe 123 slightly changes. The reason why the positional relationship “slightly changes” is that, since the pipe 123 is partially bent, it is configured to allow the entire pipe 123 to be slightly elastically deformed to be bent, like the connecting pipe 30.

The injection molding system 1 is configured to allow each of the connecting pipe 30 and the pipe 123 as a whole to be slightly elastically deformed to be bent. Thus, as illustrated in FIG. 2, a gap d required for detaching the connection member 40 from the mold 50 can be secured by slightly moving the injection cylinder 13 of the injection unit 11 to the upstream side in the center line direction. Specifically, each of the connecting pipe 30 and the pipe 123 is slightly elastically deformed while slightly moving the injection cylinder 13 to the upstream side in the center line direction to form the gap d. A length of the gap d in the center line direction is not particularly limited and may be, for example, approximately 20 millimeters (mm). The injection cylinder 13 is configured to include drive means (for example, a motor) (not shown) that is movable in the center line direction in accordance with an input operation of a worker.

The injection unit 11 slightly moves the injection cylinder 13 to the upstream side in the center line direction until the gap d is formed. An operation of detaching the connection member 40 detachably fixed to the mold 50 is performed. Then, a space 200 for performing the purge operation is formed between the injection cylinder 13 and the mold 50. Accordingly, the purge operation is performed by the injection unit 11. While the purge operation is being performed, the injection cylinder 13 slightly moved to the upstream side in the center line direction is returned to an original position. That is, the injection unit 11 returns each of the connecting pipe 30 and the pipe 123 in an elastically deformed state to a state in which each pipe is not elastically deformed, by slightly moving the injection cylinder 13 to the downstream side in the center line direction to return to the original position. Accordingly, stress caused by the elastic deformation of the connecting pipe 30 and the pipe 123 is eliminated.

### Configuration of Connection Member 40

FIG. 3 is a diagram illustrating an example of a configuration of the connection member 40.

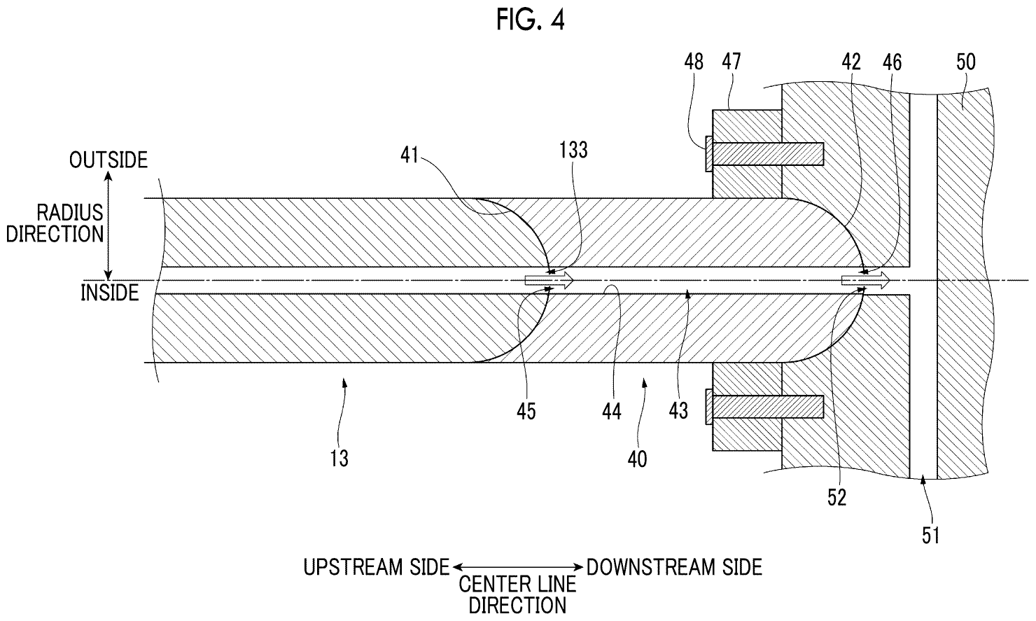

FIG. 4 is a diagram illustrating an example of a state where the injection cylinder 13, the connection member 40, and the mold 50 are connected.

As illustrated in FIGS. 3 and 4, the connection member 40 detachably fixed to the mold 50 is a linear metal pipe in which the space 43 serving as a flow path through which the molten resin flows is formed. Thus, the connection member 40 withstands heat and pressure for the flow of the molten resin. An inner surface 44 of the connection member 40 is smooth and has a non-retentive structure in which the molten resin is unlikely to be left. A length of the connection member 40 in the center line direction is not particularly limited. As long as a space for performing the purge operation or the like can be secured when the connection member 40 is detached, the length of the connection member 40 in the center line direction may be approximately several centimeters to several tens of centimeters.

The end portion 41 of the connection member 40 on the upstream side in the center line direction has a shape in which a hemispherical recess is formed and that can fit with a rounded shape of the end portion 132, on the downstream side, of the injection cylinder 13 of the injection unit 11. Accordingly, the end portion 132, on the downstream side, of the injection cylinder 13 of the injection unit 11 and the end portion 41 of the connection member 40 on the upstream side in the center line direction are easily aligned with each other. The end portion 42 of the connection member 40 on the downstream side in the center line direction includes an output port 46 for injecting the molten resin after flowing through the space 43. The end portion 42 including the output port 46 has a rounded shape that can fit with a hemispherical recess formed in the inlet 52 of the sprue 51 of the mold 50.

The connection member 40 is provided with a fixation portion 47 for detachably fixing the connection member 40 to the mold 50. The fixation portion 47 is a block-shaped metal member through which a bolt 48 passes, and detachably fixes the connection member 40 to the mold 50 with the bolt 48. The fixation portion 47 may be molded to be joined with the connection member 40 or may be fixed to an outer wall of the connection member 40 through welding or the like. The fixation portion 47 is not illustrated in FIGS. 1 and 2.

As illustrated in FIG. 4, the injection molding machine 10 performs injection molding in a state where the injection cylinder 13, the connection member 40, and the mold 50 are connected.

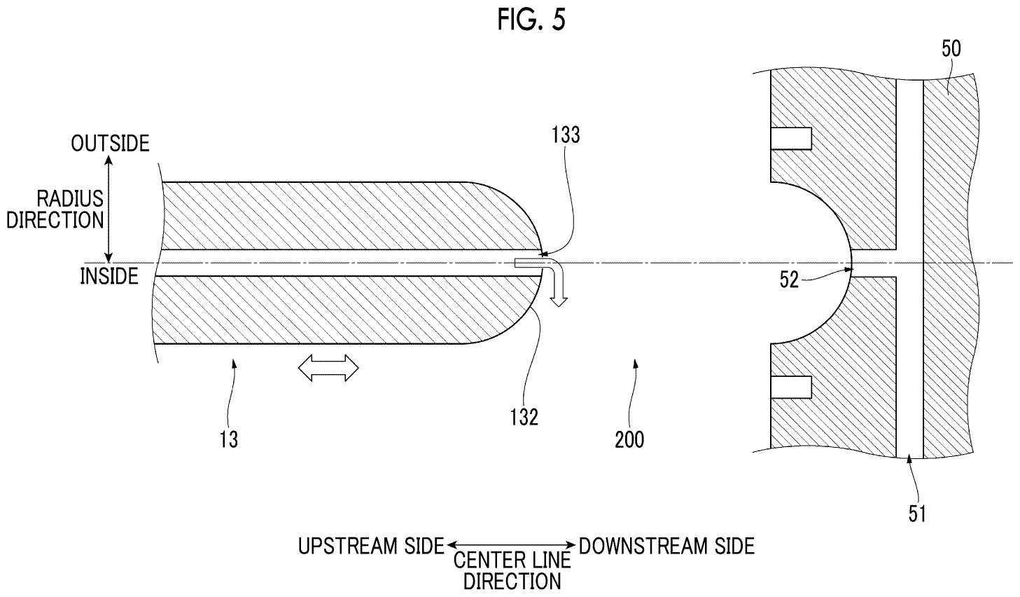

FIG. 5 is a diagram illustrating an example of a state where the connection member 40 is detached.

When the bolt 48 of the fixation portion 47 of the connection member 40 illustrated in FIG. 4 is detached, and the injection cylinder 13 is slightly moved to the upstream side in the center line direction while slightly elastically deforming each of the connecting pipe 30 and the pipe 123, the connection member 40 can be detached. The phrase “slightly moved” means that the injection cylinder 13 is moved to the upstream side in the center line direction by a distance (the gap d in FIG. 2) with which the connection member 40 from which the bolt 48 of the fixation portion 47 is detached can be detached from the mold 50.

When the connection member 40 is detached, the space 200 is formed between the injection cylinder 13 and the mold 50, as illustrated in FIG. 5. Thus, the purge operation of the injection unit 11 is performed using the space 200. That is, the purge operation can be performed by simply detaching the connection member 40 by slightly moving the whole injection unit 11 without significantly moving the whole injection unit 11 to the upstream side in the center line direction.

### Flow of Processing of Injection Unit 11

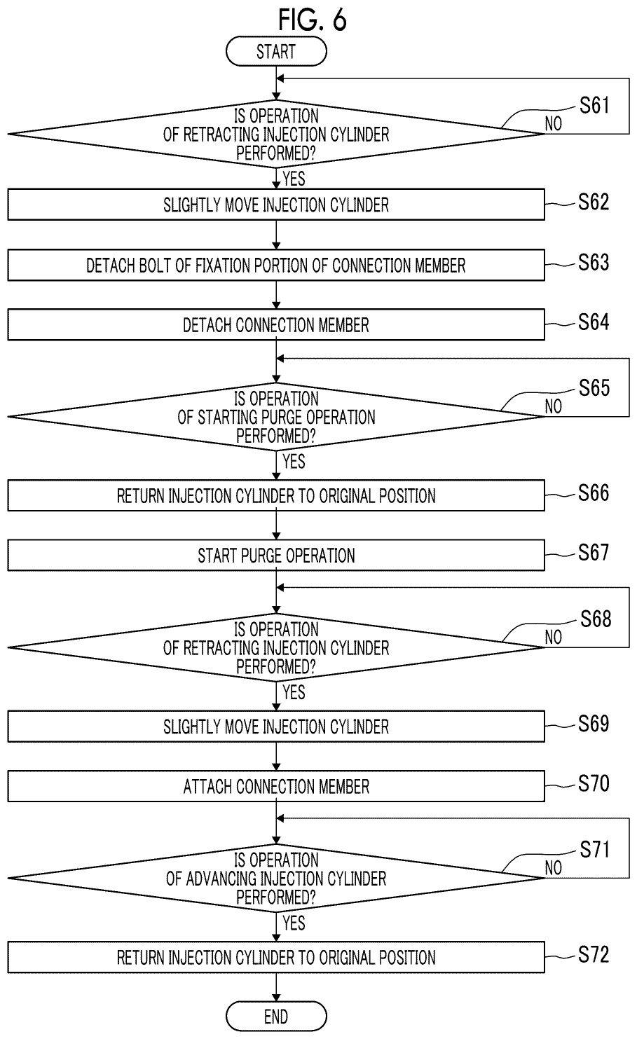

FIG. 6 is a flowchart illustrating a flow of processing when the injection unit 11 performs the purge operation.

When the injection unit 11 performs the purge operation from the state illustrated in FIG. 4, the connection member 40 is detached through the following procedure. That is, when an operation of retracting the injection cylinder 13 is performed (YES in step S61), the injection unit 11 slightly moves the injection cylinder 13 to the upstream side in the center line direction while slightly elastically deforming each of the connecting pipe 30 and the pipe 123 (step S62). Meanwhile, when the operation of retracting the injection cylinder 13 is not performed (NO in step S61), the injection unit 11 repeats the determination processing in step S61.

Next, the worker detaches the bolt 48 of the fixation portion 47 of the connection member 40 (step S63) and detaches the connection member 40 (step S64). When an operation of starting the purge operation is performed (YES in step S65), the injection unit 11 returns the injection cylinder 13 to the original position (step S66). The injection unit 11 starts the purge operation (step S67). Meanwhile, when the operation of starting the purge operation is not performed (NO in step S65), the injection unit 11 repeats the determination processing in step S65.

When the operation of retracting the injection cylinder 13 is performed after the purge operation of the injection cylinder 13 is completed (YES in step S68), the injection unit 11 performs the following processing. That is, the injection unit 11 slightly moves the injection cylinder 13 to the upstream side in the center line direction while slightly elastically deforming each of the connecting pipe 30 and the pipe 123 (step S69). Meanwhile, when the operation of retracting the injection cylinder 13 is not performed (NO in step S68), the injection unit 11 repeats the determination processing in step S68.

When the worker manually attaches the connection member 40 to the mold 50 (step S70), and an operation of advancing the injection cylinder 13 is performed (YES in step S71), the injection unit 11 performs the following processing. That is, the injection unit 11 returns the injection cylinder 13 in a slightly moved state to the upstream side in the center line direction, to the original position (step S72). Accordingly, since the end portion 132 of the injection cylinder 13 on the downstream side in the center line direction and the end portion 41 of the connection member 40 on the upstream side in the center line direction fit with each other, injection molding can be started. Meanwhile, when the operation of advancing the injection cylinder 13 is not performed (NO in step S71), the injection unit 11 repeats the determination processing in step S71.

### Modification Example

As described above, the injection unit 11 according to the present embodiment is an injection unit of a so-called pre-plunger system (also referred to as a pre-plunge system) in which the independent plasticizing cylinder 12 and the injection cylinder 13 are combined with each other. Thus, an axis of the plasticizing cylinder 12 in the center line direction and an axis of the injection cylinder 13 in the center line direction are not present on the same axis. However, the injection unit 11 of the pre-plunger system is merely an example. For example, an injection unit of an in-line screw system in which a screw and an injection cylinder are present on the same axis, and heating and injection of the molten resin are performed on the same axis may be adopted. Even in this case, as in the above embodiment, it is configured to bring the injection port of the injection unit of the in-line screw system into contact with the end portion, on the upstream side, of the connection member 40 detachably fixed to the mold 50.

As illustrated in FIGS. 3 and 4, a magnitude of a diameter, in a radius direction, of the space 43 serving as a flow path of the molten resin formed inside the connection member 40 according to the present embodiment is constant in the center line direction. However, the present invention is not limited to this. For example, the magnitude of the diameter of the space 43 in the radius direction may be gradually decreased from the upstream side to the downstream side in the center line direction. Accordingly, a pressure of the molten resin output from the output port 46 of the end portion of the connection member 40 on the downstream side in the center line direction can be efficiently increased.

In the present embodiment, it is configured to completely separate the connection member 40 from the mold 50 when all bolts 48 of the connection member 40 fixed to the mold 50 are detached. However, the present invention is not limited to this. It may be configured not to completely separate the connection member 40 from the mold 50. For example, it may be configured to connect a part of the mold 50 and a part of the connection member 40 to be rotatable using a member such as a hinge. In this case, the end portion 42 of the connection member 40 can be fitted with the inlet 52 of the sprue 51 of the mold 50 with a touch and can be separated from the inlet 52 with a touch.

While the connection member 40 according to the present embodiment is configured to be fixed to a side closer to the mold 50, the connection member 40 may be configured to be fixed to a side closer to the injection cylinder 13.

In the present embodiment, the connecting pipe 30 that connects the output unit 20 and the injection unit 11 is a metal pipe that is partially bent. Thus, a degree to which the connecting pipe 30 is deformed when the injection cylinder 13 is slightly moved to the upstream side in the center line direction is a degree to which the positional relationship between the end portion (the part connected to the output unit 20) of the connecting pipe 30 on the upstream side and the end portion (the part connected to the plasticizing cylinder 12) of the connecting pipe 30 on the downstream side slightly changes. That is, the present embodiment assumes that a shape of the connecting pipe 30 is not significantly deformed. However, the present invention is not limited to this, and a sleeve may be provided in the connecting pipe 30. Accordingly, since the injection unit 11 can be significantly moved to the upstream side in the center line direction, the space 200 formed by detaching the connection member 40 can be further expanded.

The flow of processing illustrated in the flowchart of FIG. 6 is an example and is not particularly limited. For example, in the flowchart of FIG. 6, the injection cylinder 13 is slightly moved to the upstream side in the center line direction (step S62), and then an operation of detaching the bolt 48 of the fixation portion 47 of the connection member 40 is performed (step S63). Accordingly, the connection member 40 is prevented from falling when the injection cylinder 13 is slightly moved. However, the present invention is not limited to this order of processing. For example, the injection cylinder 13 may be slightly moved to the upstream side in the center line direction after the operation of detaching the bolt 48 of the fixation portion 47 of the connection member 40 is performed. Accordingly, since the connection member 40 can be detached while slightly moving the injection cylinder 13, time for elastically deforming the connecting pipe 30 and the pipe 123 can be reduced. Consequently, stress caused by the elastic deformation of the connecting pipe 30 and the pipe 123 can be reduced.

In summary, the injection molding machine 10 according to the present embodiment may have the following configuration and can be embodied in various manners.

That is, the injection molding machine 10 is an injection molding machine including the mold 50 for molding the molten resin, the injection unit 11 including the injection port 133 through which the molten resin is injected, and the connection member 40 having a pipe shape that is disposed between the mold 50 and the injection port 133, and through which the molten resin injected from the injection port 133 is input from an input port 45 of the end portion 41 and output from the output port 46 of the end portion 42 to the mold 50, in which, when the injection unit 11 slightly moves in a direction away from the mold 50, the gap d with which the connection member 40 can be detached is formed between the injection unit 11 and the mold 50.

Accordingly, through the connection member 40 disposed between the mold 50 and the injection port 133, the molten resin injected from the injection port 133 is input from the input port 45 of the end portion 41 and output from the output port 46 of the end portion 42 to the mold 50. When the injection unit 11 slightly moves in the direction away from the mold 50, the gap d is formed between the injection unit 11 and the mold 50. Thus, the connection member 40 can be detached. When the connection member 40 is detached, the space 200 for performing the purge operation of the injection unit 11 is formed. Consequently, a space for performing the purge operation or the like can be formed between the injection unit 11 and the mold 50 without significantly deforming a part of the connecting pipe 30 for directly inputting the output molten resin into the injection molding machine 10 through sliding or the like. Specifically, the space 200 of several centimeters to several tens of centimeters corresponding to the length of the connection member 40 in the center line direction can be formed.

The injection unit 11 can slightly move in the direction away from the mold 50 by elastically deforming the pipe (for example, the connecting pipe 30 and the pipe 123) through which the molten resin flows, and the pipe (for example, the connecting pipe 30 and the pipe 123) through which the molten resin flows can be returned to the state in which the pipe is not elastically deformed, by returning the injection unit 11 in the slightly moved state to the original position.

Accordingly, since the injection unit 11 can be slightly moved in the direction away from the mold 50 by elastically deforming the pipe through which the molten resin flows, the gap d with which the connection member 40 can be detached is formed between the injection unit 11 and the mold 50. When the connection member 40 is detached, the space 200 for performing the purge operation of the injection unit 11 is formed. Consequently, a space with which the purge operation or the like can be performed can be formed between the injection unit 11 and the mold 50 without significantly deforming a part of the connecting pipe 30 for directly inputting the output molten resin into the injection molding machine 10 through sliding or the like. Stress caused by the elastic deformation of the connecting pipe 30 and the pipe 123 can be eliminated.

The connection member 40 may be detachably fixed to the mold 50 when the injection unit 11 slightly moves in the direction away from the mold 50.

Accordingly, an operation of fixing the connection member 40 to the mold 50 while injection molding is being performed and detaching the connection member 40 from the mold 50 while the purge operation is being performed can be easily performed.

The hemispherical recess formed in the inlet 52 of the sprue 51 that can fit with the rounded shape of the tip end (the end portion 132 on the downstream side) of the injection port 133 in the mold 50, and the hemispherical recess formed in the end portion 41 of the connection member 40 may have approximately the same shape, and the rounded shape of the tip end of the injection port 133 and the rounded shape of the end portion 42 of the connection member 40 may be approximately the same shape. The statement that the hemispherical recess formed in the inlet 52 of the sprue 51 and the hemispherical recess formed in the end portion 41 of the connection member 40 have approximately the same shape means that the hemispherical recess formed in the inlet 52 of the sprue 51 and the hemispherical recess formed in the end portion 41 of the connection member 40 have the same shape or have shapes that are not the same and are approximately the same such that the injected resin does not leak. The statement that the rounded shape of the tip end of the injection port 133 and the rounded shape of the end portion 42 of the connection member 40 are approximately the same shape means that the rounded shape of the tip end of the injection port 133 and the rounded shape of the end portion 42 of the connection member 40 are the same shape or shapes that are not the same and are approximately the same such that the resin does not leak when the resin is injected.

Accordingly, the end portion 132, on the downstream side, of the injection cylinder 13 of the injection unit 11 and the end portion 41 of the connection member 40 on the upstream side in the center line direction are easily aligned with each other. Only the connection member 40 may be manufactured in accordance with the shape of the injection port 133 of the injection unit 11 and the shape of the inlet 52 of the sprue 51 of the mold 50 fitting with the injection port 133 without newly designing the shapes.

The injection molding system 1 according to the present embodiment may have the following configuration and can be embodied in various manners. That is, the injection molding system 1 is an injection molding system including the injection molding machine 10 including the mold 50 for molding the molten resin, the injection unit 11 including the injection port 133 through which the molten resin is injected, and the connection member 40 having a pipe shape that is disposed between the mold 50 and the injection port 133, and through which the molten resin injected from the injection port 133 is input from the input port 45 of the end portion 41 and output from the output port 46 of the end portion 42 to the mold 50, in which, when the injection unit 11 slightly moves in the direction away from the mold 50, the gap d with which the connection member 40 can be detached is formed between the injection unit 11 and the mold 50; the output unit 20 that outputs the molten resin; and the connecting pipe 30 that connects the output unit 20 and the injection unit 11, and through which the molten resin output from the output unit 20 flows to the injection unit 11.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a mold for molding a molten resin;
an injection unit including an injection port through which the molten resin is injected; and
a connection member substantially having a pipe shape that is disposed between the mold and the injection port, and through which the molten resin injected from the injection port is input from one end and output from the other end to the mold,
wherein, when the injection unit moves in a direction away from the mold, a gap with which the connection member is detachable is formed between the injection unit and the mold.

2. The injection molding machine according to claim 1,
wherein the injection unit moves in the direction away from the mold by elastically deforming a pipe through which the molten resin flows, and the pipe through which the molten resin flows is returned to a state in which the pipe is not elastically deformed, by returning the injection unit in a moved state to an original position.

3. The injection molding machine according to claim 2,
wherein the injection unit includes a plasticizing cylinder that delivers a required amount of the molten resin by heating the molten resin, and an injection cylinder that injects the molten resin delivered from the plasticizing cylinder into the mold.

4. The injection molding machine according to claim 3,
wherein the pipe through which the molten resin flows is disposed in an end portion of the plasticizing cylinder.

5. The injection molding machine according to claim 4,
wherein the pipe is a metal pipe that is partially bent, and a space serving as a flow path through which the molten resin flows is formed inside the pipe.

6. The injection molding machine according to claim 3,
wherein the injection cylinder includes a plunger that pressurizes the molten resin delivered from the plasticizing cylinder through the pipe, and the injection port through which the molten resin that is pressurized is injected into the mold.

7. The injection molding machine according to claim 1,
wherein the connection member is detachably fixed to the mold when the injection unit moves in the direction away from the mold.

8. The injection molding machine according to claim 7,
wherein the connection member is provided with a fixation portion for detachably fixing the connection member to the mold.

9. The injection molding machine according to claim 8,
wherein the fixation portion is a substantially block-shaped metal member through which a bolt passes, and detachably fixes the connection member to the mold with the bolt.

10. The injection molding machine according to claim 1,
wherein a substantially hemispherical recess formed in an inlet of a sprue fittable with a substantially rounded shape of a tip end of the injection port in the mold and a substantially hemispherical recess formed at the one end of the connection member have the same shape, and the substantially rounded shape of the tip end of the injection port and a substantially rounded shape of the other end of the connection member are the same shape.

11. An injection molding system comprising:
an injection molding machine including
a mold for molding a molten resin,
an injection unit including an injection port through which the molten resin is injected, and
a connection member substantially having a pipe shape that is disposed between the mold and the injection port, and through which the molten resin injected from the injection port is input from one end and output from the other end to the mold,
in which, when the injection unit moves in a direction away from the mold, a gap with which the connection member is detachable is formed between the injection unit and the mold;
an output unit that outputs the molten resin; and
a connecting pipe that connects the output unit and the injection unit, and through which the molten resin output from the output unit flows to the injection unit.
